(19) United States
(12) Patent Application Publication
(10) Pub. No.: US 2006/0109980 A1
(43) Pub. Date: May 25, 2006

(54) Portable wireless communication device

(76) Inventor: Yuichi Miyazaki, Tokyo (JP)

Correspondence Address: INTELLECTUAL PROPERTY / TECHNOLOGY LAW, PO BOX 14329, RESEARCH TRIANGLE PARK, NC, 27709, US

(21) Appl. No.: 10/994,590

(22) Filed: Nov. 19, 2004

(51) Int. Cl. H04M 1/00; H04M 9/00

(52) U.S. Cl. 379/433.12

(57) ABSTRACT

A portable wireless communication device with enhanced ability to capture speech. The portable wireless communication device may be configured to include: a main housing having a microphone in its lower portion; a movable housing having a speaker in its upper portion; a sliding mechanism for guiding the movable housing so that it freely slides longitudinally along a sliding plane on the main housing, wherein the main housing uniformly becomes thin from its lower portion through to its upper portion; and the sliding plane is inclined from the lower portion through to the upper portion of the main housing. This configuration enables the movable housing to slide along the main housing, shortening the distance between the microphone and the speaker's mouth, thereby improving the ability of the microphone to capture speech.

### BACKGROUND OF THE INVENTION

1. Field of the Invention

The present invention relates to a portable wireless communication device, and more specifically, to a housing structure for improving a microphone's ability to capture speech.

2. Description of the Related Art

As disclosed in Japanese Patent Publication No. HEI 10-271192, portable telephones with sliding housing structures are known. This type of portable telephone has a movable housing which is guided so that the movable housing freely slides along the guide grooves of a main housing that includes dial keys and a microphone, etc. For ease of carrying in standby mode, the dial keys and microphone of such portable telephones are covered by the movable housing, and during a call, the movable housing is slid open, exposing the dial keys and microphone.

However, in the arrangement in which the movable housing is slid downward, it is difficult to position the microphone close to the speaker' mouth, and thus, to improve the microphone' ability to capture speech. Since the human face curves from the ear to the mouth, a desirable configuration is one in which, when the movable housing is slid along the main housing, the microphone comes as close as possible to the speaker's mouth, following the shape of the face.

### SUMMARY OF THE INVENTION

The present invention resolves the above-mentioned problem by the provision of a portable wireless communication device that improves the microphone's ability to capture speech.

In one aspect, the invention relates to a portable wireless communication device, including: a main housing having a microphone in its lower portion; a movable housing having a speaker in its upper portion; a sliding mechanism for guiding the movable housing so that it freely slides longitudinally along a sliding plane on the main housing, wherein the main housing uniformly becomes thin from its lower portion through to its upper portion; and the sliding plane is inclined from the lower portion through to the upper portion of the main housing. This constitution enables positioning of the microphone close to the speaker's mouth by sliding the movable housing along the main housing, improving the microphone's ability to capture speech. Furthermore, since the distance between the microphone and the speaker's mouth can be increased or decreased freely according to how far the movable housing is slid, a portable wireless communication device superior in its ability to capture speech and convenience is achieved.

Other aspects, features and embodiments of the invention will be more fully apparent from the ensuing disclosure and appended claims.

### BRIEF DESCRIPTION OF THE DRAWINGS

FIG. 1 is a plain view of a portable wireless communication device, according to one embodiment of the present invention, in standby mode.

FIG. 2 is a cross-sectional view of the portable wireless communication device shown in FIG. 1.

FIG. 3 is a plain view of a portable wireless communication device, according to one embodiment of the present invention, during a call.

FIG. 4 is a cross-sectional view of the portable wireless communication device shown in FIG. 3.

### DESCRIPTION OF THE PREFERRED EMBODIMENT

The preferred embodiment of the present invention is explained below with reference to each of the drawings.

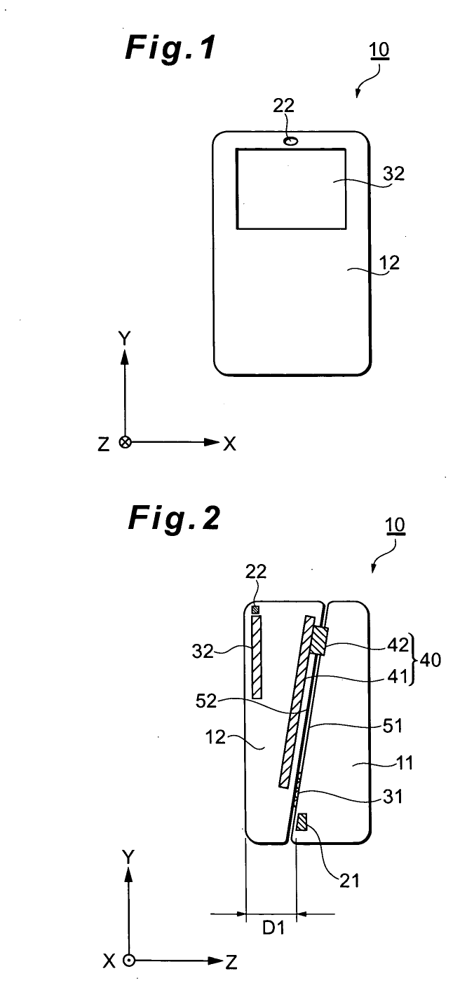

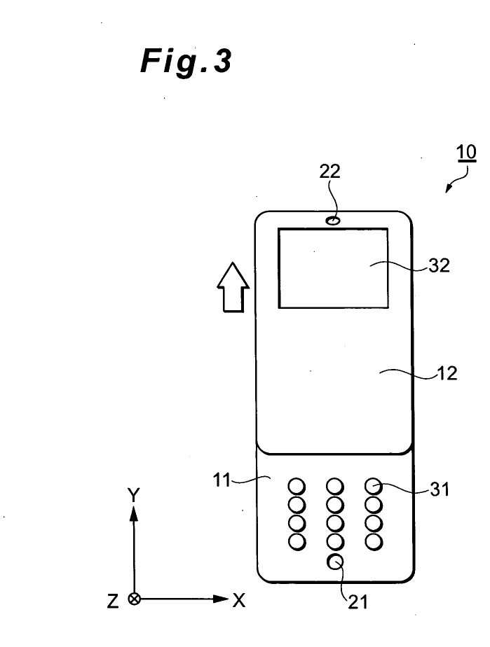

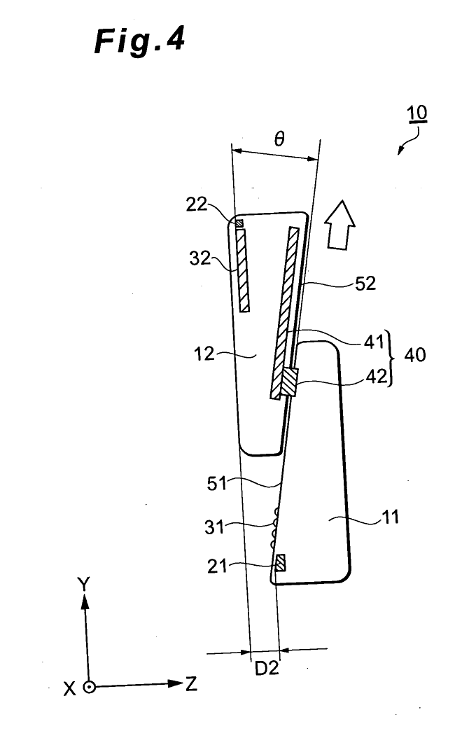

FIG. 1 is a plain view of a portable wireless communication device 10, according to the present invention, in standby mode. FIG. 2 is a cross-sectional view of the communication device shown in FIG. 1. FIG. 3 is a plain view of the portable wireless communication device 10, according to the present invention, during a call. FIG. 4 is a cross-sectional view of the communication device shown in FIG. 3. In these figures, the X-direction is the latitudinal direction (width direction), the Y-direction is the longitudinal direction, and the Z-direction is the thickness direction, of a housing of the portable wireless communication device 10.

The portable wireless communication device 10 is a mobile communication terminal, such as a mobile phone or a PHS phone. As shown in the figures, the portable wireless communication device 10 includes a main housing 11, constituting the main portion of the entire device, and a movable housing 12 guided so that it freely slides along the main housing 11. The main housing 11 is equipped with dial keys 31 for inputting dial numbers, etc., and a microphone 21 for audio input. The microphone 21 is in the lower portion of the main housing 11. Meanwhile, the movable housing 12 is equipped with a display 32 for displaying dial numbers, etc., and a speaker 22 for audio output. The speaker 22 is in the upper portion of the movable housing 12. The display 32 is, for example, a liquid crystal display.

As shown in FIGS. 2 and 4, the movable housing 12 is provided with a sliding mechanism 40 for guiding the movable housing 12 so that it freely slides longitudinally along a sliding plane 51 on the main housing 11. The sliding mechanism 40 comprises a linear guide groove 41 formed at both sides of the movable housing 12, and an engaging unit 42 that engages with the guide groove 41 and guides the movable housing 12 so that it freely slides along the guide groove 41. The guide groove 41 is formed roughly in parallel with the sliding plane 51. Moreover, the main housing 11 is formed roughly in a trapezoid shape such that it uniformly becomes thin from its lower portion through to its upper portion, and thus, it has a plane (sliding plane 51) declined from its lower portion through to its upper portion. Meanwhile, the movable housing 12 is formed in a roughly trapezoidal shape so that it uniformly becomes thin from its upper portion through to its lower portion, and thus, it has a plane (sliding plane 52) declined from its upper portion through to its lower portion. In FIG. 4, θ is the inclination angle formed by the front surface plane of the portable wireless communication device 10 and the sliding plane 52 of the movable housing 12.

FIGS. 1 and 2 mainly show the status of the portable wireless communication device 10 in standby mode or when not in use, where the movable housing 12 has been slid closed so that dial keys 31 and the microphone 21 are not exposed. Meanwhile, FIGS. 3 and 4 mainly show the status of the portable wireless communication device 10 during a call, where the movable housing 12 is slid open so that the dial keys 31 and the microphone 21 are exposed. Thus, the movable housing 12 is slid longitudinally, bringing the microphone 21 to the speaker's mouth. In addition, the distance between the microphone 21 and the front surface plane of the portable wireless communication device 10 can be adjusted by sliding the movable housing 12. For example, the distance D2 between the microphone 21 and the front surface plane of the portable wireless communication device 10 when the movable housing 12 is slid up the main housing 11 is shorter than the distance D1 between the microphone 21 and the front surface plane of the portable wireless communication device 10 when the movable housing 12 is slid up the main housing 11.

As stated above, by having the sliding plane 51 inclined relative to the back surface of the portable wireless communication device 10 and sliding the movable housing 12 up the main housing 11 along the sliding plane 51, the distance between the microphone 21 and the front surface plane of the portable wireless communication device 10 is shortened, bringing the microphone close to the speaker's mouth. Thus, the microphone's ability to capture speech is improved.

As a result of the display 32 being on the movable housing 12, and spatially unrestricted by the arrangement of the dial keys 31, a thin and easy-to-carry portable wireless communication device 10 with a good display 32 is achieved.

While the invention has been described herein with reference to illustrative features and embodiments, other variations, modifications and alternative embodiments of the invention will readily suggest themselves to those of ordinary skill in the art based on the disclosure herein, and therefore are to be regarded as being within the spirit and scope of the invention.

What is claimed is:

1. A portable wireless communication device, comprising:
a main housing having a microphone in its lower portion;
a movable housing having a speaker in its upper portion;
a sliding mechanism for guiding the movable housing so that it freely slides longitudinally along a sliding plane on the main housing,
wherein the main housing uniformly becomes thin from its lower portion through to its upper portion; and the sliding plane is inclined from the lower portion through to the upper portion of the main housing.

2. The portable wireless communication device of claim 1, wherein the main housing comprises dial keys for inputting dial numbers; and the movable housing when slid open exposes the dial keys.
